(19) United States
(12) Patent Application Publication
(10) Pub. No.: US 2007/0023274 A1
(43) Pub. Date: Feb. 1, 2007

(54) Display apparatus

(75) Inventors: Tai-hung Kim, Suwon-si (KR); Hyun-yong Choi, Chuncheon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/491,974

(22) Filed: Jul. 25, 2006

(30) Foreign Application Priority Data
Jul. 27, 2005 (KR) 2005-68556

(51) Int. Cl. H05F 3/00

(52) U.S. Cl. 204/164

(57) ABSTRACT

A display apparatus includes a display panel, a casing formed with an opening and to accommodate the display panel, an anion generator disposed with the casing and having an electrode and a circuit part connected to the electrode to drive the electrode to generate anions, and a covering member provided between the opening in the casnig and the anion generator and having a conductive main body plate including an anion discharging part to discharge the anions generated by the anion generator and a ground part extending from the main body plate within the casing. Thus, the display apparatus can stably discharge anions through an anion ventilation aperture.

### CROSS-REFERENCE TO RELATED APPLICATIONS

This application claims priority from Korean Patent Application No. 2005-0068556, filed on Jul. 27, 2005, in the Korean Intellectual Property Office, the disclosure of which is incorporated herein by reference in its entirety.

### BACKGROUND OF THE INVENTION

1. Field of the Invention

The present general inventive concept relates to a display apparatus, and more particularly, to a display apparatus having an anion generator.

2. Description of the Related Art

In general, a display apparatus includes a display main body for forming an image and a base, which is mounted on an installation surface such as a table, for supporting the display main body. A display apparatus commonly refers to a device for forming an image such as TV, a computer monitor, etc.

The display main body mainly has a thin plate shape and may be a display panel such as an LCD (liquid crystal display) or a PDP (plasma display panel).

Recently, a display has been developed having an anion generator which generates anions that are beneficial to a human body.

A conventional display apparatus having the anion generator is described in Japanese Patent First Publication No. 2004-24933. The conventional display apparatus includes the anion generator mounted within a casing to generate the anions, a power switch to turn on/off the anion generator, and a ventilation aperture provided in the casing to discharge the anions generated by the anion generator out of the casing. Accordingly, the conventional display apparatus can provide a user with anions by discharging the anions generated by an electrode of the anion generator out of the casing of the display apparatus.

However, in the conventional display apparatus, the anions may be adhered to the anion ventilation aperture and may be accumulated thereon when the anions pass the ventilation aperture, thereby hindering the discharge of the anions.

### SUMMARY OF THE INVENTION

Accordingly, the present general inventive concept provides a display apparatus which can stably discharge anions through an anion ventilation aperture.

Additional aspects of the general inventive concept will be set forth in the description which follows, and in part will be apparent from the description, or may be learned by practice of the general inventive concept.

The foregoing and/or other aspects of the present general inventive concept are achieved by providing a display apparatus comprising a display panel, a casing formed with an opening and to accommodate the display panel, an anion generator disposed within the casing and having an electrode and a circuit part to drive the electrode to generate anions, and a covering member provided between the opening in the casing and the anion generator and having a conductive main body plate including an anion discharging part to discharge the anions generated by the anion generator and a ground part extending from the main body plate within the casing.

The display apparatus may further comprise a fastening part provided on the casing to support the anion generator, and the ground part being combined to the fastening part.

The ground part may be connected to the circuit part.

The circuit part may comprise a driving circuit to supply a high voltage power to the electrode, and a circuit casing to accommodate the driving circuit and to support the electrode.

The ground part may be connected to a ground of the driving circuit.

The display apparatus may further comprise a connection member having a first side connected to the ground of the driving circuit, and a second side exposed outside of the circuit casing to contact the ground part.

The circuit casing, the ground part, and the connection member may be combined with the fastening part by a screw.

The covering member includes a protrusion part that protrudes from the main body plate to be inserted into the opening and the protrusion part includes the anion discharging part.

The display apparatus may further comprise an anion LED adjacent to the electrode and spaced apart therefrom to emit light when the anions are generated by the electrode, an LED penetration part formed in the main body plate so that the light generated by the anion LED passes therethrough, and a blocking part extending from the main body plate between the electrode and the anion LED to block the light generated by the anion LED from being exposed via the anion discharging part.

The foregoing and/or other aspects of the present general inventive concept are also achieved by providing a display apparatus, including a casing to accommodate a display panel, an anion generator disposed in the casing and having an electrode portion to generate anions, and a grounded plate portion disposed opposite to the electrode portion and having an anion discharging outlet through which the anions are discharged out of the casing such that any of the anions that are not discharged out of the casing are eliminated.

The foregoing and/or other aspects of the present general inventive concept are also achieved by providing a display apparatus, including a casing, an electrode disposed in the casing to generate anions, and a plate disposed on an outer portion of the casing opposite to the electrode and having an opening through which the anions flow out of the casing, the plate being electrically grounded.

The foregoing and/or other aspects of the present general inventive concept are also achieved by providing a display apparatus casing, including a particle generating part disposed on an inner portion of the display apparatus casing to generate particles of a first predetermined electric potential, and a discharge outlet member disposed opposite the particle generating part and extending through the display apparatus casing and having a throughole therein to discharge the particles, the discharge outlet member being maintained at a second predetermined electric potential different from the first predetermined electric potential to eliminate particles that are not discharged through the throughhole.

It is to be understood that both the foregoing general description and the following detailed description are exemplary and explanatory and are intended to provide further explanation of the general inventive concept as claimed.

### BRIEF DESCRIPTION OF THE DRAWINGS

These and/or other aspects of the present general inventive concept will become apparent and more readily appreciated from the following description of the exemplary embodiments, taken in conjunction with the accompany drawings, in which:

FIG. 1 is a perspective view illustrating a display apparatus according to an embodiment of the present general inventive concept,

FIG. 2 is a rear perspective view illustrating the display apparatus of FIG. 1, provided with an anion generator according to an embodiment of the present general inventive concept.

FIG. 3 is an exploded perspective view illustrating the anion generator and a covering member of the display apparatus of FIG. 2.

FIG. 4 is a front exploded perspective view illustrating the anion generator and the covering member of the display apparatus of FIG. 2, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

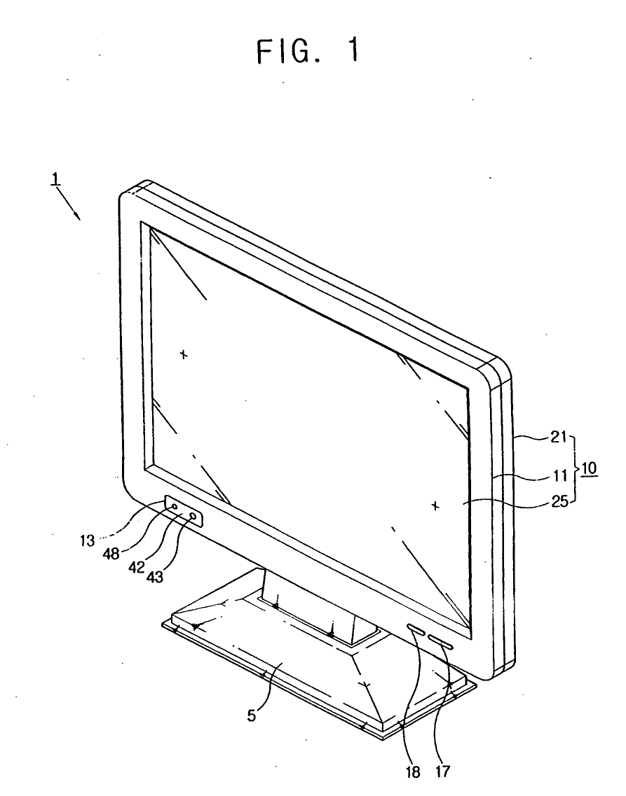

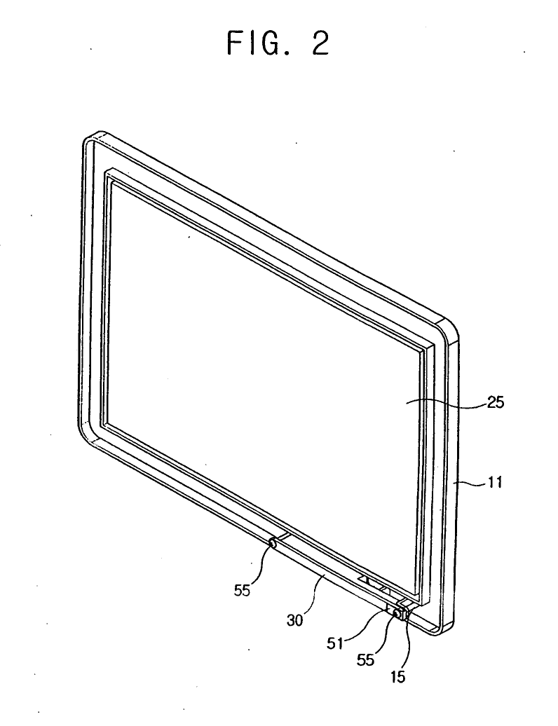

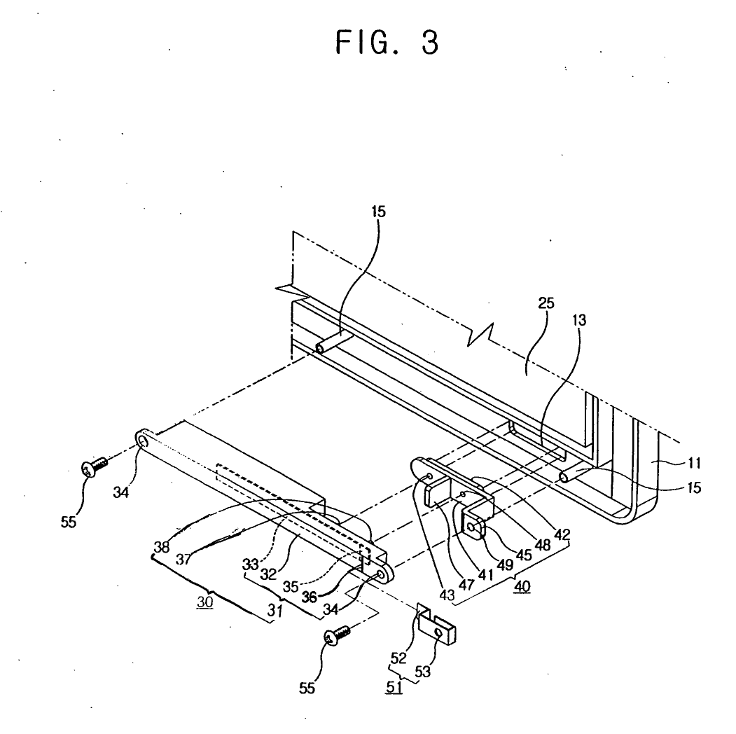

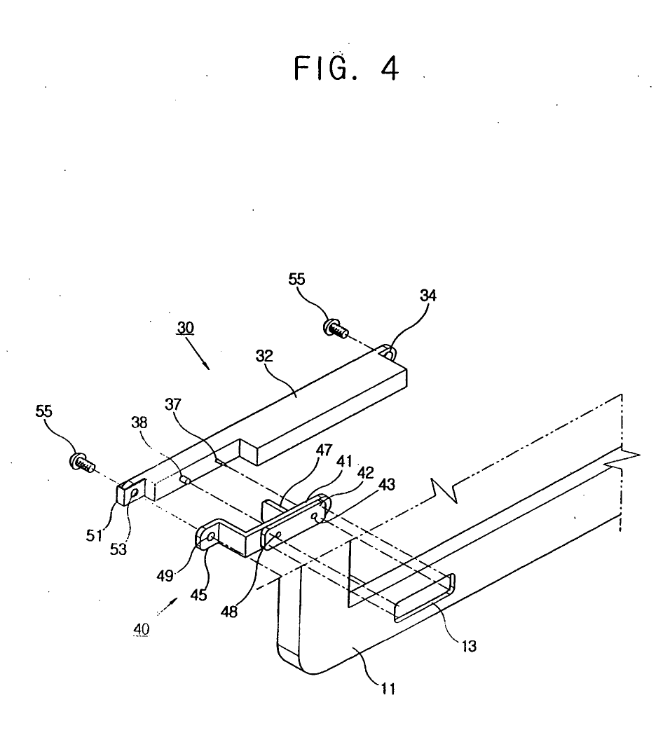

FIG. 1 is a perspective view illustrating a display apparatus 1 according to an embodiment of the present general inventive concept. FIG. 2 is a rear perspective view illustrating the display apparatus 1 provided with an anion generator 30. FIG. 3 is an exploded perspective view illustrating the anion generator 30 and a covering member 40 of the display apparatus 1. FIG. 4 is a front exploded perspective view illustrating the anion generator 30 and the covering member 40 of the display apparatus 1. As illustrated in FIGS. 1 to 4, the display apparatus 1 includes a display main body 10 having a display panel 25 to form an image and casings 11 and 21 (e.g., front and rear casings 11 and 21, respectively) to accommodate and support the display panel 25, a base 5 to support the display main body 10 on an installation surface, the anion generator 30 provided within the casings 11 and 21 to generate anions, and the covering member 40 provided between the casings 11 and 21 and the anion generator 30.

The display panel 25 may include a flat plate type display such as an LCD (liquid crystal display) or a PDP (plasma display panel). The display panel 25 is driven by a driving circuit unit (not shown) mounted within the casings 11 and 21.

The casings 11 and 21 include the front casing 11 provided at a front of the display panel 25, and the rear casing 21 provided at a rear of the display panel 25. The casings 11 and 21 are provided with an opening 13 formed to correspond to the covering member 40, and a plurality of fastening parts 15 to support the anion generator 30. The anion generator 30 includes an electrode 37 to generate the anions, and is covered by the covering member 40.

The front casing 11 may be provided with a power switch 17 to turn on/off the display panel 25, and an anion switch 18 to turn on/off the anion generator 30.

As illustrated in FIGS. 3 and 4, the opening 13 may be formed at a lower region of the front casing 11. The opening 13 has a size that corresponds to the electrode 37 and an anion LED 38 (Light Emitting Diode) mounted on the anion generator 30. The opening 13 receives and accommodates a protrusion part 42 of the covering member 40 that covers the electrode 37 and the anion LED 38. It should be understood that the opening 13 may be provided on an upper side or region of the front casing 11 according to a location of the anion generator 30, and may also be provided on the rear casing 21.

As illustrated in FIGS. 1 to 3, the plurality of fastening parts 15 are provided such that the fastening parts 15 extend from a back surface of the front casing 11 in a rear direction. Each fastening part 15 is coupled with a casing joint 34 of the anion generator 30 and a covering member joint 49 of the covering member 40 by a screw 55 so as to support the anion generator 30 and the covering member 40 together with respect to the casings 11 and 21.

The anion generator 30 includes the electrode 37 provided within the casings 11 and 21, and a circuit part 31 connected to the electrode 37 to cause the electrode 37 to generate anions. The anion generator 30 may further include the anion LED 38 connected to the circuit part 31 to emit light when the anions are generated from the electrode 37.

As illustrated in FIG. 3, the circuit part 31 includes a circuit casing 32 to accommodate a driving circuit 33 mounted in the circuit casing 32 to supply a high voltage power to the electrode 37. The circuit part 31 may be connected to a ground unit 45 of the covering member 40 which will be described below.

The circuit casing 32 supports the electrode 37 so that the electrode 37 connected to the driving circuit 33 extends from the circuit casing 32, and the circuit casing 32 also supports the anion LED 38 so as to be spaced apart from the electrode 37. The circuit casing 32 is provided with the casing joint 34 to be coupled with the fastening parts 15 by the screws 55. The circuit casing 32 encloses the driving circuit 33 and blocks contact with the driving circuit 33, thereby isolating the driving circuit 33 and blocking electronic waves generated from the driving circuit 33. The circuit casing 32 is formed with a connection member penetration part 36 so that a connection member 51 can be connected to the driving circuit 33 therethrough.

The driving circuit 33 is mounted within the circuit casing 32 to supply power to the electrode 37, the anion LED 38, etc. In the present embodiment, the driving circuit 33 may be connected to the anion switch 18 to supply the power to the electrode 37 when the anion switch 18 is turned on. Alternatively, the anion switch 18 may not be connected to the driving circuit 33, and the driving circuit 33 may instead be connected to the power switch 17 to supply the power to the electrode 37 when the power switch 17 is turned on. For example, the driving circuit 33 may be connected to the power switch 17 when the power switch 17 and the anion switch 18 are formed as one switch.

In the present embodiment, the driving circuit 33 can generate a voltage of 4000V and supply the 4000V voltage to the electrode 37. However, the driving circuit 33 may generate a variety of voltages ranging from 1000V to 10000V, and is not necessarily limited to the 4000V. The driving circuit 33 is connected to the anion LED 38 and supplies power to the anion LED 38 so as to cause the anion LED 38 to emit light when the anions are generated by the electrode 37. In the present embodiment, the driving circuit 33 may apply the power to the anion LED 38 when the anion switch 18 is turned on. Alternatively, the driving circuit 33 may supply the power to the anion LED 38 when the power switch 17 is turned on when the anion switch 18 is not connected to the driving circuit 33, or when there is no separate anion switch 18. The driving circuit 33 is provided with a ground 35. The ground 35 of the driving circuit 33 may be connected to the connection member 51 to be connected to a ground part 45 of the covering member 40.

The electrode 37 is disposed on the circuit casing 32 to be connected to the driving circuit 33. The electrode 37 can be attached to the circuit casing 32, for example, by adhesives. The electrode 37 is supplied with a high voltage power by the driving circuit 33, and generates the anions by causing a discharge with the covering member 40 made of a conductive material, or with an ambient air. The electrode 37 can be shaped to sharply point toward a front direction so that the discharge can be easily generated with the covering member 40, or with the ambient air.

The anion LED 38 is disposed on the circuit casing 32 adjacent to the electrode 37 to be attached to the driving circuit 33. The anion LED 38 can be connected to the circuit casing 32, for example, by adhesives. The anion LED 38 emits light out of the opening 13 in the front casing 11 through an LED penetration part 48 of the main body plate 41.

The covering member 40 is provided between the opening 13 of the casings 11 and 21 and the anion generator 30. The covering member 40 includes the main body plate 41 made of a conductive material having an anion discharging part 43, and the ground part 45 extending from the main body plate 41. The covering member 40 includes the protrusion part 42 extending from the main body plate 41 to be inserted into the opening 13, and the protrusion part 42 includes the anion discharging part 43. The anion discharging part 43 may be an opening extending through the main body plate 41 and the protrusion part 42 of the covering member 40. Additionally, the main body plate 41 has a larger area than the opening 13 in the front casing 13 such that the protrusion part 42 can be accommodated therein without being removable therethrough. The covering member 40 can further include a blocking part 47 to block light generated from the anion LED 38 from being exposed via the anion discharging part 43.

The main body plate 41 is formed of a material to have a plate shape between the front casing 11 formed with the opening 13 and the anion generator 30. The main body plate 41 may, for example, be formed of a conductive metal material. Alternatively, the main body plate 41 can be formed by coating the conductive material on another material. The main body plate 41 is provided in front of the electrode 37 spaced by a predetermined distance from the electrode 37. The main body plate 41 is formed of the conductive material and causes the discharge with the electrode 37 to generate the anions.

The anion discharging part 43 is formed on the main body plate 41 located in front of the electrode 37 to enable the anions generated by the electrode 37 to be easily discharged through the opening 13 in the front casing 11. The anion discharging part 43 may have a size such that the anion discharging part 43 can prevent foreign material and debris from flowing in toward the electrode 37 while efficiently discharging the anions. The anion discharging part 43 may have a diameter of about 3 mm. Alternatively, the anion discharging part 43 can have a diameter of more than 4 mm or less than 2 mm depending on the display apparatus 1 or a location of the anion discharging part 43 on the display apparatus 1.

Thus, the anions generated by the electrode 37 can be transferred through the anion discharging part 43 to a user located in front of the display apparatus 1. The anions generated by the electrode 37 are accumulated on the anion discharging part 43 and the main body plate 41 by the dielectric polarization phenomena. The anions that are adhered to the anion discharging part 43 may tend to block or impede other anions from flowing through the anion discharging part 43 due to a repelling force among anions.

The LED penetration part 48 is formed on the main body plate 41 located in front of the anion LED 38 to enable the light generated by the anion LED 38 to be easily discharged through the opening in the casings 11 and 21, via the covering member 40.

The blocking part 47 extends from the main body plate 41 in the direction of the anion generator 30. The blocking part 47 is provided in the shape of a plate between the electrode 37 and anion LED 38, and can block the light emitted from the anion LED 38 from being exposed via the anion discharging part 43.

The protrusion part 42 extends in a front direction of the main body plate 41 and corresponds to the opening 13 of the front casing 11. The protrusion part 42 is formed with the anion discharging part 43 and the LED penetration part 48 extending therethrough.

The ground part 45 extends from the main body plate 41 to eliminate the anions adhered to the main body plate 41 and the anion discharging part 43. The ground part 45 is provided with the covering member joint 49 to be coupled to the fastening part 15 by the screw 55. The ground part 45 can be connected to the circuit part 31 to eliminate the anions adhered to the main body plate 41 and anion discharging part 43. That is, the ground part 45 can be connected to the ground 35 of the driving circuit 33 of the circuit part 31. However, it is also possible that the ground part 45 is grounded via the driving circuit part (not shown) of the display panel 25 using a separate cable. Thus, the anions that are adhered to the anion discharging part 43 are eliminated by using the ground part 45, and thus accumulation of the anions on the anion discharging part 43 is prevented. Accordingly, the anions can be discharged stably. In other words, since the main body plate 41 and the anion discharging part 43 are grounded via the ground part 45, the anions adhered thereto are also grounded, and therefore do no block, impede, or repel the flow of other anions through the anion discharging part 43.

The connection member 51 is formed of a conductive material and is provided between the ground part 45 and circuit part 31 to connect each other. A first side of the connection member 51 is connected to the ground 35 of the driving circuit 33, and a second side of the connection member 51 is exposed out of the circuit casing 32 to contact the ground part 45 of the covering member 40. The first side of the connection member 51 is provided with a ground contact part 52 which contacts the ground 35 of the driving circuit 33 by penetrating the connection member penetration part 36 of the circuit casing 32. The second side of the connection member 51 is provided with a connection member joint 53 to be coupled with the fastening part 15 of the front casing 11 and the covering member joint 49 by the screw 55. The second side of the connection member 51 can be coupled with the fastening part 15 by the screw 55 integrally with the circuit casing 32 and the ground part 45, and the first side extends inside of the circuit casing 32 to contact the ground 35 of the driving circuit 33. Thus, the ground part 45 can be grounded via the driving circuit 33 of the anion generator 30 through the connection member 51. It should be understood that although the embodiments describe screws 55, other fasteners or fastening elements can be used to couple the casings 11 and 21 to the covering member 40, the anion generator 30, and the connection member 51.

An operation of the covering member 40 of the display apparatus 1 according to an embodiment of the present general inventive concept will be described as follows.

The anion switch 18 is turned on to operate the anion generator 30. Then, the power is supplied from the circuit part 31 to the electrode 37, and the anions are generated by the electrode 37 by a discharge between the electrode 37 and the main body plate 41. The anions are discharged out of the casings 11 and 21 through the anion discharging part 43 of the main body plate 41 by a natural convection. Thus, the anions generated by the anion generator 30 can be discharged through the anion discharging part 43. The anions that are adhered to the anion discharging part 43 and the main body plate 41 are eliminated by being grounded through the ground part 45 of the covering member 40 and the connection member 51 to the anion generator 30. Thus, the anions generated by the anion generator 30 can be stably discharged through the anion discharging part 43 without being blocked or repelled by other anions adhered to these components.

As described above, a display apparatus according to the various embodiments of the present general inventive concept can easily prevent anions from adhering to an anion discharging part of a main body plate by having a ground part made of a conductive material extending from the main body plate. Also, the display apparatus can easily ground the ground part to an anion generator using a connection member.

As described above, the embodiments of the present general inventive concept can stably discharge anions from the anion discharging part by preventing anions that are adhered to an anion discharging part of the main body plate from blocking, impeding, or repelling a flow of other anions.

Further, the embodiments of the present general inventive concept can easily ground the ground part via an anion generator using a connection member.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising:
a display panel;
a casing formed with an opening and to accommodate the display panel;
an anion generator disposed within the casing and having an electrode and a circuit part connected to the electrode to drive the electrode to generate anions; and
a covering member provided between the opening in the casing and the anion generator and having a conductive main body plate including an anion discharging part to discharge the anions generated by the anion generator and a ground part extending from the main body plate within the casing.

2. The display apparatus according to claim 1, further comprising:
a fastening part provided on the casing to support the anion generator, and the ground part being combined to the fastening part.

3. The display apparatus according to claim 1, wherein the ground part is connected to the circuit part.

4. The display apparatus according to claim 1, wherein the circuit part comprises:
a driving circuit to supply a high voltage power to the electrode; and
a circuit casing to accomodate the driving circuit and to support the electrode.

5. The display apparatus according to claim 4, wherein the ground part is connected to a ground of the driving circuit.

6. The display apparatus according to claim 5, further comprising:
a connection member having a first side connected to the ground of the driving circuit and a second side exposed outside of the circuit casing to contact the ground part.

7. The display apparatus according to claim 6, wherein the circuit casing, the ground part, and the connection member are combined with the fastening part by a screw.

8. The display apparatus according to claim 1, wherein the covering member includes a protrusion part that protrudes from the main body plate to be inserted into the opening and the protrusion part includes the anion discharging part extending therethrough.

9. The display apparatus according to claim 1, further comprising:
an anion LED adjacent to the electrode and spaced apart therefrom to emit light when the anions are generated by the electrode;
an LED penetration part formed in the main body plate so that the light generated by the anion LED passes therethrough; and
a blocking part extending from the main body plate between the electrode and the anion LED to block the light generated by the anion LED from being exposed via the anion discharging part.

10. The display apparatus according to claim 2, further comprising:
an anion LED adjacent to the electrode and spaced apart therefrom to emit light when the anions are generated by the electrode;
an LED penetration part formed in the main body plate so that the light generated by the anion LED passes therethrough; and
a blocking part extending from the main body plate between the electrode and the anion LEDto block the light generated by the anion LED from being exposed via the anion discharging part.

11. The display apparatus according to claim 3, further comprising:
an anion LED adjacent to the electrode to be spaced apart therefrom to emit light when the anions are generated by the electrode;
an LED penetration part formed in the main body plate so that the light generated by the anion LED passes therethrough; and
a blocking part extending from the main body plate between the electrode and the anion LED to block the light generated by the anion LED from being exposed via the anion discharging part.

12. The display apparatus according to claim 4, further comprising:
an anion LED adjacent to the electrode and spaced apart therefrom to emit light when the anions are generated from the electrode;
an LED penetration part formed in the main body plate so that the light generated by the anion LED passes therethrough; and
a blocking part extending from the main body plate between the electrode and the anion LED to block the light generated by the anion LED from being exposed via the anion discharging part.

13. The display apparatus according to claim 5, further comprising:
an anion LED adjacent to the electrode and spaced apart therefrom to emit light when the anions are generated by the electrode;
an LED penetration part formed in the main body plate so that the light generated by the anion LED passes therethrough; and
a blocking part extending from the main body plate between the electrode and the anion LED to block the light generated by the anion LED from being exposed to the anion discharging part.

14. The display apparatus according to claim 6, further comprising:
an anion LED adjacent to the electrode and spaced apart therefrom to emit light when the anions are generated by the electrode;
an LED penetration part formed in the main body plate so that the light generated by the anion LED passes therethrough; and
a blocking part extending from the main body plate between the electrode and the anion LED to block the light generated by the anion LED from being exposed via the anion discharging part.

15. The display apparatus according to claim 7, further comprising:
an anion LED adjacent to the electrode and spaced apart therefrom to emit light when the anions are generated by the electrode;
an LED penetration part formed in the main body plate so that the light generated by the anion LED passes therethrough; and
a blocking part extending from the main body plate between the electrode and the anion LED to block the light generated by the anion LED from being exposed via the anion discharging part.

16. The display apparatus according to claim 8, further comprising:
an anion LED adjacent to the electrode and spaced apart therefrom to emit light when the anions are generated by the electrode;
an LED penetration part formed in the main body plate so that the light generated by the anion LED passes therethrough; and
a blocking part extending from the main body plate between the electrode and the anion LED to block the light generated by the anion LED from being exposed via the anion discharging part.

17. A display apparatus, comprising:
a casing to accommodate a display panel;
an anion generator disposed in the casing and having an electrode portion to generate anions; and
a grounded plate portion disposed opposite to the electrode portion and having an anion discharging outlet through which the anions are discharged out of the casing such that any of the anions that are not discharged out of the casing are eliminated.

18. The display apparatus according to claim 17, wherein the anion generator comprises:
a circuit casing having the electrode portion disposed thereon; and
a driving circuit disposed in the circuit casing to drive the electrode portion to generate the anions and having a ground part.

19. The display apparatus according to claim 18, further comprising:
a connection member to connect the ground part with the grounded plate portion.

20. The display apparatus according to claim 17, further comprising:
a covering member having the grounded plate portion and being disposed between the casing and the anion generator in an opening of the casing such that the anions are discharged from the anion discharging outlet through the opening.

21. The display apparatus according to claim 20, wherein:
the casing comprises a fastening part;
the covering member comprises a covering member joint coupled to the fastening part of the casing; and
the anion generator comprises a casing joint coupled to the fastening part of the casing and the covering member joint of the covering member.

22. The display apparatus according to claim 21, wherein the grounded plate portion of the covering member is connected to a ground part of the anion generator through the covering joint member and the casing joint.

23. The display apparatus according to claim 21, wherein the covering member joint, the casing joint, and the fastening part are coupled together via a fastener.

24. The display apparatus according to claim 21, wherein any anions that adhere to the grounded plate portion are eliminated such that the adhered anions do not impede a flow of anions through the anion discharging outlet.

25. The display apparatus according to claim 21, further comprising:
an anion LED disposed in the casing to emit light when the electrode portion generates the anions,
wherein the grounded plate portion includes a light discharging outlet to discharge the light from the casing.

26. The display apparatus according to claim 21, wherein the anion discharging outlet extends through the casing.

27. A display apparatus, comprising:
a casing;
an electrode disposed in the casing to generate anions; and
a plate disposed on an outer portion of the casing opposite to the electrode and having an opening through which the anions flow out of the casing, the plate being electrically grounded.

28. The display apparatus according to claim 27, further comprising:
a driving circuit to drive the electrode to generate the anions and having a ground part to which the plate is connected.

29. The display apparatus according to claim 28, further comprising:
a circuit casing disposed in the casing to house the driving circuit and to support the electrode and having a penetration part through which the plate is connected to the ground part of the driving circuit.

30. A display apparatus casing, comprising:
a particle generating part disposed on an inner portion of the display apparatus casing to generate particles of a first predetermined electric potential; and
a discharge outlet member disposed opposite the particle generating part and extending through the display apparatus casing and having a throughole therein to discharge the particles, the discharge outlet member being maintained at a second predetermined electric potential different from the first predetermined electric potential to eliminate particles that are not discharged through the throughole.

31. The display apparatus casing according to claim 30, wherein the first predetermined electric potential is negative and the second predetermined electric potential is ground.
